(19) United States
(12) Patent Application Publication
(10) Pub. No.: US 2020/0189679 A1
(43) Pub. Date: Jun. 18, 2020

(54) A BICYCLE BRAKE LIGHT SYSTEM

(71) Applicant: Richard Walford, Saffron Walden (GB)

(72) Inventor: Richard Walford, Saffron Walden (GB)

(21) Appl. No.: 16/607,891

(22) PCT Filed: Apr. 25, 2018
(86) PCT No.: PCT/GB2018/000073

§ 371 Date: Oct. 24, 2019

(30) Foreign Application Priority Data
Apr. 25, 2017 (GB) 1706585.5

(51) Int. Cl. B62J 6/045; B62J 6/01

(52) U.S. Cl. CPC B62J 6/045; B62J 6/01

(57) ABSTRACT

A bicycle brake light system includes a sensor unit which is configured to measure the braking force applied to a bicycle brake cable; a light unit including a light and which is configured to mount at or towards the rear of a bicycle so that the light from the light is directed substantially rearwards in use; and a controller configured to receive the output from the sensor unit and to control the light such that the intensity of light emitted by the light is dependent on the amount of braking force applied.

### FIELD

The present invention relates to a bicycle brake light system. More particularly, the present invention relates to a bicycle brake light system where the brake light intensity is dependent on the intensity of the applied braking force.

### BACKGROUND

It is uncommon for bicycles to include the features that are required on motorised vehicles such as turn signals, brake lights, and similar. Although bicycles at night are required to have rear lights, these provide constant illumination, or at least a light that is not indicative of the speed or changes in speed of the bicycle. The differential speeds of bicycles as against other vehicular traffic can mean that a slowing bicycle may not be immediately or swiftly noticed by the driver of another moving vehicle behind the decelerating bicycle, especially in the case of a sharply slowing bicycle under heavy braking force, and for example in dark or poor visibility conditions.

WO16088148A describes a braking signalling system which can be used for bicycles, which has a Bluetooth device that communicates with a pressure sensor in order to detect pressure variation in the braking force, to turn on a beacon with an intensity that is in proportion to the pressure exerted on the handlebar brake grip.

DE10162466A describes and shows a device for varying brake light intensity which has sensors with associated magnets that interact with one or more lighting bodies, so that the magnets move near to and relative to the sensors during the braking process to vary the brake light intensity.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a bicycle brake light system which goes some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in a bicycle brake light system, comprising: a sensor assembly, configured to measure the force applied to a bicycle brake lever during braking; a light unit comprising at least one light, the light unit configured for mounting so that light from the at least one light can be directed substantially rearwards in use, and; a controller configured to receive the output from the sensor assembly and to control the light such that the intensity of light emitted is dependent on the amount of braking force applied.

Measuring the braking force applied allows the system to be set up to provide illumination progressively or with increasing intensity, to a level appropriate to the braking force, which then allows the provision of a visual form that intuitively allows other road users to gauge the braking intensity, and to react appropriately in response.

In an embodiment, the at least one light comprises a plurality of lights, the controller configured to illuminate the lights sequentially in order to increase the intensity of light emitted. This provides a visual form that intuitively allows other road users to gauge the braking intensity, and to react appropriately in response.

In an embodiment, the plurality of lights are arranged to form two or more rings. This provides a visual form that intuitively allows other road users to gauge the braking intensity, and to read appropriately in response.

In an embodiment, the two or more rings are arranged substantially concentrically. This provides a visual form that intuitively allows other road users to gauge the braking intensity, and to react appropriately in response.

In an embodiment, the controller is configured to illuminate the rings from the inner ring outwards. This provides a visual form that intuitively allows other road users to gauge the braking intensity, and to react appropriately in response.

In an embodiment, the plurality of lights are arranged to form three rings. This provides a simple and intuitive visual form.

In an embodiment, the lights comprise LED lights. These provide a simple, robust and effective form of lighting.

In an embodiment, the light unit further comprises a light housing, the controller and housing configured so that the controller is located in the housing. This shelters the lights and controller and allows their use as a single unit.

In an embodiment, the sensor assembly comprises a strain gauge, mounted to in use measure the force applied to a brake lever. This provides a reliable, robust and accurate way to measure braking force.

In an embodiment, the strain gauge is mounted in line with the brake cable associated with the brake lever. This provides a reliable, robust and accurate way to measure braking force.

In an embodiment, the sensor assembly further comprises an elongate main body having a pair of poles mounted one at each end to extend from one side thereof, the free ends of the brake cable connected one to each of the poles at or towards the outer end of the pole, the strain gauge mounted on the surface of the main body between the poles. This provides a reliable, robust and accurate way to measure braking force.

In an embodiment, the main body comprises at least one cut-out section on the opposite side of the main body to the poles and strain gauge. This helps with accurate measurement of the braking force.

In an embodiment, the cut-out section or sections is/are substantially opposite the strain gauge. This helps with accurate measurement of the braking force.

In an embodiment, the sensor unit further comprises a housing configured to hold and at least partly enclose the sensor unit. This shelters the sensors and assists with it's use as a single unit.

In an embodiment, the controller is configured to receive an output signal from the sensor assembly indicative of the force applied to the bicycle brake lever during braking and to convert this to an output voltage substantially proportional to the braking force. This assists with providing a visual form that intuitively allows other road users to gauge the braking intensity, and to react appropriately in response.

In an embodiment, the output voltage is substantially between zero and five volts. This allows the unit to be built in a way that is compact, robust, and lightweight.

In an embodiment, the control circuitry is configured to step up the intensity of the light emitted when the output voltage reaches each one of a series of pre-set levels. This assists with providing a visual form that intuitively allows other road users to gauge the braking intensity, and to react appropriately in response.

In an embodiment, the bicycle brake light assembly further comprises a hardwired connection between the sensor assembly and the light unit. This provides a robust form of signal transmission, and also power transmission if required.

In an embodiment, the sensor assembly further comprises a wireless transmitter, and the light unit further comprises a wireless receiver configured to receive a signal transmitted from the wireless transmitter, the signal indicative of the amount of braking force applied. This allows flexibility in the mounting of the light unit or light units, and allows them to be remotely located away from the bicycle if required.

In an embodiment, the transmitter and receiver are configured to use the Bluetooth protocol.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a top view of a bicycle fitted with a bicycle brake light system according to an embodiment of the invention, the bicycle brake light system having a rear light unit fitted to the rear of the bicycle to direct light rearwards in use, and a sensor unit fitted in line with the front brake cable to measure the force applied to the brake lever by the user.

FIG. 2a shows a schematic view of the bicycle brake light system of FIG. 1, showing detail of the braking system of the bicycle including the brake lever, brake cable and brake unit, a housing for the sensor unit, the sensor unit fitted in line with the brake cable to directly measure the braking force applied during braking, and the light unit, connected to the sensor unit via a hardwired cable connection.

FIG. 2b shows a variation on the system of FIG. 2a, a second light unit present in this variation and communicating with the sensor unit wirelessly rather than by hardwired cable, the second light unit having no hardwire connection to the remainder of the system.

FIG. 2c shows a variation on the system of FIGS. 2a and 2b, first and second light units present in this variation and each communicating with the sensor unit wirelessly rather than by hardwired cable.

FIG. 3 shows a cutaway perspective view of the interior of the housing of the sensor unit, showing detail of a sensor assembly located in the housing, the sensor assembly having a central main body with two poles extending perpendicularly from one side of the body, the free ends of the brake cable connected to the poles so that in use a pulling or linear force is applied to the poles during braking, which causes a bending moment in the main body, a strain gauge mounted between the poles configured to measure the amount of bend and to transmit this to a control unit.

FIG. 4 shows a schematic side view of the strain gauge assembly of FIG. 3, showing detail of the main body, the poles, and the strain gauge, the arrows showing the linear force applied to the poles by the brake cable when a user pulls on the brake.

FIG. 5 shows a perspective side view of the rear light unit, showing the light housing and a rearwards facing light assembly mounted in the housing.

FIG. 6 shows a rear view of the rear light unit, showing detail of the light assembly of this embodiment, which comprises three concentric circular rings of LEDs that light sequentially from the centre ring outwards in use when a braking force is applied, the first or innermost ring lighting when any braking force (a force greater than zero) is applied, the second and third rings lighting when the braking force applied is over a certain pre-set threshold for activation of that ring.

FIGS. 7a-7d show rear views of the rear light unit, showing sequentially from left to right the light with no braking force applied (all lights off), and the three rings lighting sequentially from the inner ring outwards as increasing braking force is applied and the braking force rises over the threshold necessary for illumination of each ring.

FIG. 8 shows a circuit diagram for a circuit that forms part of the control unit for this embodiment of brake light system, the circuit being an amplifier circuit for the strain gauge that receives the analogue braking signal from the strain gauge and converts and amplifies this to a voltage output signal that is used to control the light.

FIG. 9 shows a graph of braking force F vs output voltage V for the brake light system of the present invention, the lower graph line showing the detected displacement of the brake cable, the upper line showing the output voltage from the amplifier circuit, the dotted vertical lines showing the threshold points for the minimum braking force required to illuminate the second and third rings of lights, the first/centre ring illuminating for any detected braking force over zero or close to zero.

### DETAILED DESCRIPTION

Embodiments of the invention, and variations thereof, will now be described in detail with reference to the figures.

An embodiment of the bicycle brake light system 1 of the present invention has two main parts: a light unit 2 and a sensor unit 3.

As shown in FIG. 1, in an embodiment, the light unit 2 is in use mounted at the rear of a bicycle, so that the light from the light unit 2 can be seen by other road users behind the cyclist. The sensor unit 3 in this embodiment is mounted on or close to the brake unit of the bicycle (the brake lever and handlebar clamp). In this embodiment, the sensor unit 3 is mounted in line with the front brake cable, close to the brake lever and handlebar clamp, as described in detail below.

It should be noted that the light unit 2 could be mounted, elsewhere on the bicycle as required, or remotely mounted, such as for example on the helmet, belt or backpack of a user, or a similar location.

### Light Unit

As shown in FIG. 5, the light unit 2 comprises a light housing 4 and a rear light assembly 5 which comprises multiple individual lights—in this embodiment three concentric rings of LED lights 5a, 5b, 5c mounted on and forming part of the light unit 2. The light housing 4 and LED light rings 5a, 5b, 5c appear circular when viewed from directly behind in use, with a common centrepoint (three concentric rings of lights). It should be noted that the light rings can be formed as non-circular shapes, for example oval, square, or triangular, and can have a non-common centrepoint. The minimum number of lights for an outer ‘ring’ is therefore three (three points of a triangle), and a single light could form a central ‘ring’. However, single lights or pairs of lights could also be used—for example an inner single light with a surrounding ring or rings, or an inner single light flanked at it's sides (e.g. left-right, or above-below) by one or more pairs of lights, to form a line (straight or otherwise) of lights, that illuminate sequentially—e.g. from the inside outwards (centre light then flanking lights). ‘Sequential’ as it is used in this specification should be taken to mean lighting a first light or lights and then subsequently lighting a further light or lights.

In this embodiment, the light housing 4 houses the batteries and electronic circuitry necessary for powering and controlling the system. Electric wires/cables 8 extend from the housing 4, these acting to receive signals from the sensor unit 3.

### Sensor Unit

The sensor unit 3 is positioned and configured so that it directly measures the force applied to the brake lever by the user. In this embodiment, the sensor unit 3 is in communication with the front brake lever, as this is the brake most used by a typical user: the majority of braking force is applied via this lever, most frequently. The sensor unit 3 in this embodiment is mounted so that is in line with the front brake cable 10—the brake cable 10 passes into and out of the housing, with a sensor assembly 6 in line with cable as described below. The sensor unit 3 comprises a sensor housing 9, that houses a sensor assembly 6. The housing 9 in this embodiment comprises a cylindrical tube that in use is mounted or clamped to the handlebars of the bicycle just to the inner side of the handlebar clamp and brake lever. Alternatively, the housing 9 could be mounted on the handlebar post or the bicycle frame.

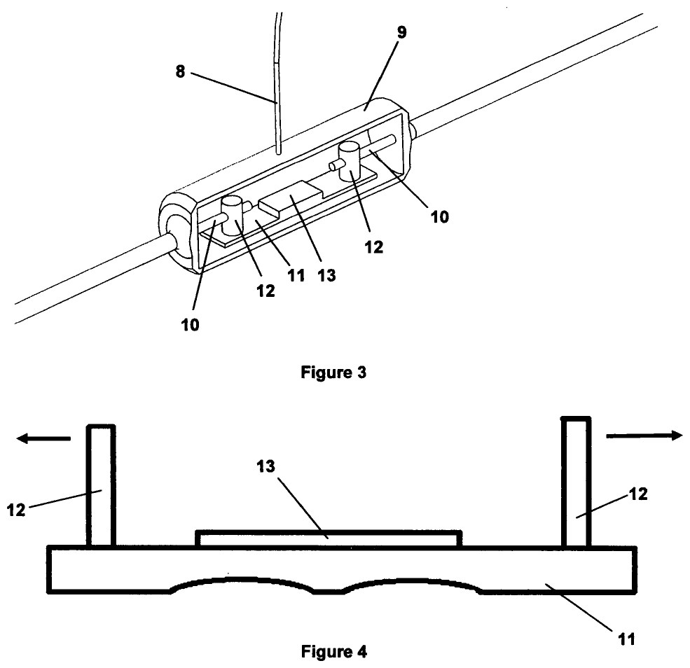

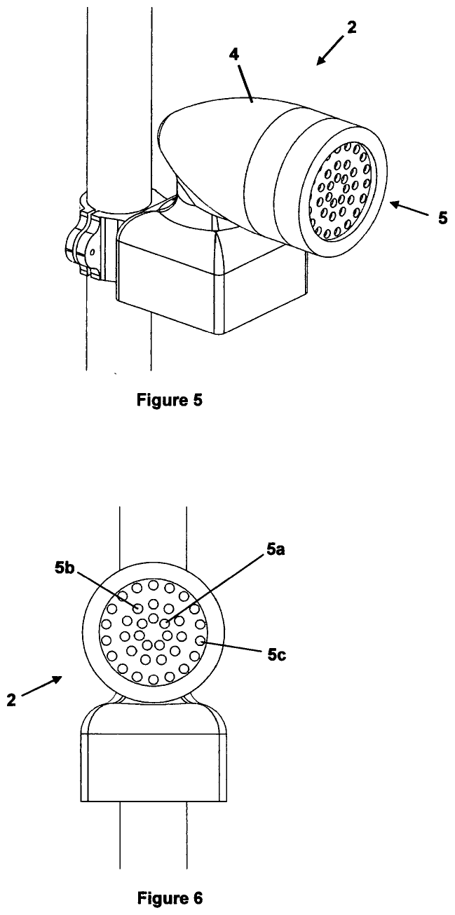

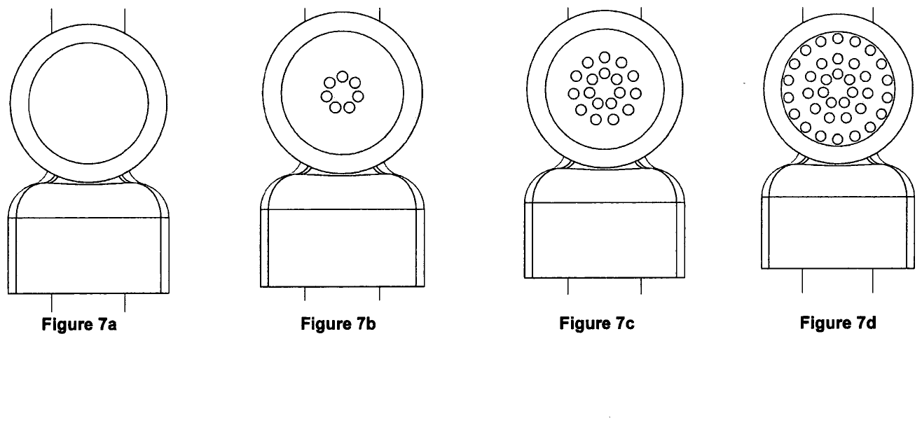

The brake cable 10 passes from the brake lever into one end of the housing 9, and out of the other. As shown in FIG. 3, the brake cable 10 is broken inside the housing, so that there are two free ends—a lever end and a brake end. The lever end of the brake cable 10 is connected to one end of the sensor assembly 6. The other end of the cable—the brake end—is connected to the other end of the sensor assembly 6 (the light end) the cable then passing from the sensor assembly 6 out of the other end of the housing 9 and to the brakes 15. That is, the sensor assembly 6 is mounted in line with or ‘interrupting’ the brake cable 10.

The sensor assembly 6 in this embodiment comprises an elongate and generally cuboid main body 11, having a pair of metal poles 12 that are connected to and which extend perpendicularly from an upper face of the main body, towards each end of the main body 11 (it should be noted that directional descriptors such as ‘upper’, ‘lower’ and similar are intended to indicate relative directions rather then absolute, and the sensor assembly will operate effectively in any orientation). The lever end of the brake cable 10 is connected to one of the poles 12, and the light end of the brake cable 10 is connected to the other of the poles 12, the connections made at or close to the top (outer end) of the poles 12. The main body 11 has cut out sections on the opposite face from that which the poles 12 extend from (the ‘lower’ face). It can be seen that if a force is applied to the cable 10 (i.e when a braking force is applied), this will pull the poles 12 in opposite directions, outwards from the main body 11. As the connection between the cable 10 and the poles 12 is offset from the main/central axis of the main body 11, application of this force causes a bending moment to be applied to the main body 11. The cut-out sections on the lower face allow or assist with bending of the main body 11—that is, less force is required in order to cause a certain amount of displacement or bend. A strain gauge 13 is mounted to the top face of the main body 11 (on the same side/face as the poles 12). When the braking force is applied and the main body 11 distorts or bends in response, this is sensed by the strain gauge 13. The cables 8 are connected to the strain gauge 13, and send a signal to the circuitry 14 in the light housing 4. The strain gauge 13 and main body 11 are sized and shaped so that any bending in normal use takes place within limits, to allow a direct/linear relationship to the pulling or braking force. In this way, the small movements or small changes that occur are accurately measured.

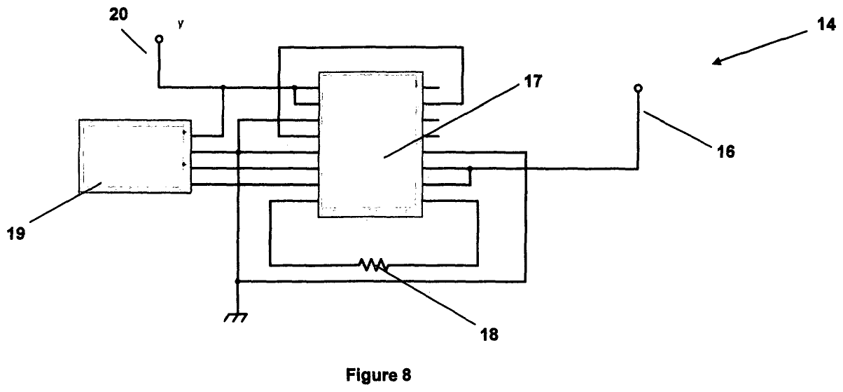

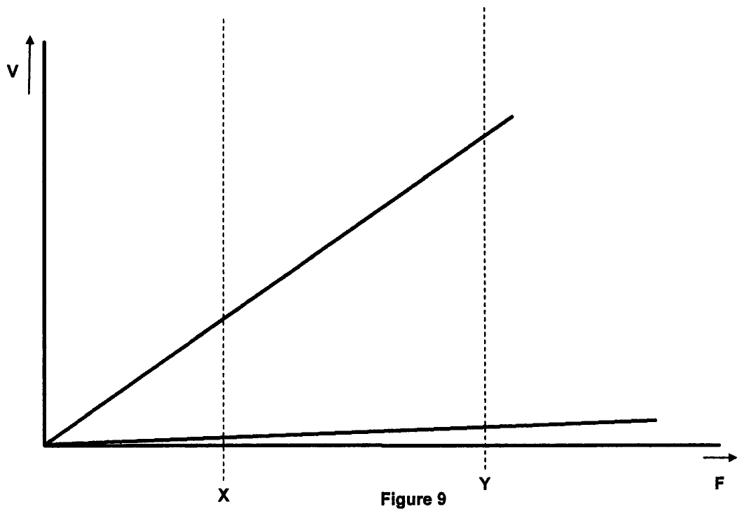

The housing 4 holds circuitry 14. In this embodiment, the signal from the sensor is transmitted via the cables or wires 8 that run from the sensor 6 to the electronic circuitry in the light unit 2, as outlined above. A circuit diagram for an amplifier circuit that forms part of the control circuitry, and which is suitable for converting the analogue force signal as received to an output voltage is shown in FIG. 8. The input signal 16 as received is converted by circuitry (consisting in this embodiment of a signal amplifier 17, a 10-Ohm resistor 18, and a load cell 19) to a low current signal that varies between zero and five volts depending on the braking force applied, and which is used to control the light assembly 5. The circuitry is powered by a 5V supply 20. The power source (not shown) that provides the 5V supply can be located in the light unit or sensor unit as preferred. The control circuitry is configured to activate each ring 5a, 5b, 5c that comprise the light assembly 5 sequentially, from the inner ring 5a outwards, as the low current signal rises above certain pre-set levels or ‘steps’, as shown in FIG. 9. The first/inner ring 5a is lit when the current is at any value above zero (it should be noted that a certain small ‘threshold’ step can be built in at this point, to avoid the light illuminating from a very small signal that might be generated by minor non-braking movement in use—for example the brake lever or housing or similar jolting or vibrating as the bicycle is ridden over bumps or similar). The second ring 5b (along with the already-lit first ring 5a) is lit when the current rises above a threshold level X, as shown in FIG. 9. The third ring 5c (along with the already lit first and second rings 5a, 5b) is lit when the current rises above a threshold level Y.

Other forms of signal transmission are also possible, rather than transmission via the cables 8. For example, the signal could be transmitted wirelessly from the sensor unit 3 to the light unit 2. In this embodiment, the control circuitry can be mounted with the sensor, along with a power source (battery) for the sensor unit 3, separate to the power source for the light unit 2, which is located in the housing 4. It should be noted that the power source can be replaceable batteries, or a rechargeable internal integrated source or battery, that can be recharged via any suitable mechanism, such as for example via a docking station, a power cable or USB cable, or wireless charging via a pad or docking station or similar.

The transmission could be made wirelessly using the Bluetooth protocol, or any other suitable RF communication. Wireless communication can be applied where communication is required between a fully wired system and an auxiliary light unit (see below)—that is, where the main light unit 2 is hardwire-connected to the sensor unit 3, but communication with auxiliary units is via wireless communication, or communication between the sensor unit 3 and the main light unit or units 2 is wireless—that is, all communication is wireless.

The bicycle brake light system 1 as described above can be mounted to a bicycle as part of an aftermarket fit or retrofit. Alternatively, the system 1 could be built into or designed into the bicycle as a standard OEM fitting, or ‘from the factory’. When the system is retrofitted, it can be fitted to or with exposed portions of the cable. For example, some braking systems have internal cables that run mainly within the frame. However, the cable is exposed where it emerges from the frame near the handlebars, and the relevant parts of the bicycle brake light system 1 can be fitted at this point. Alternatively, if provided, the part or parts of the bicycle brake light system 1 can be fitted to or in a slot or space provided by the manufacturer for this purpose.

As described above, the housing 4 is a single unit, allowing the light unit 2 to be mounted for example on the saddle stem below the saddle, or in a similar location. In alternative forms, the housing 4 could be two or more split units or multiple units, each having a number of lights or light rings. This would allow lights to be mounted for example each side of the rear wheel.

### Auxiliary Lights

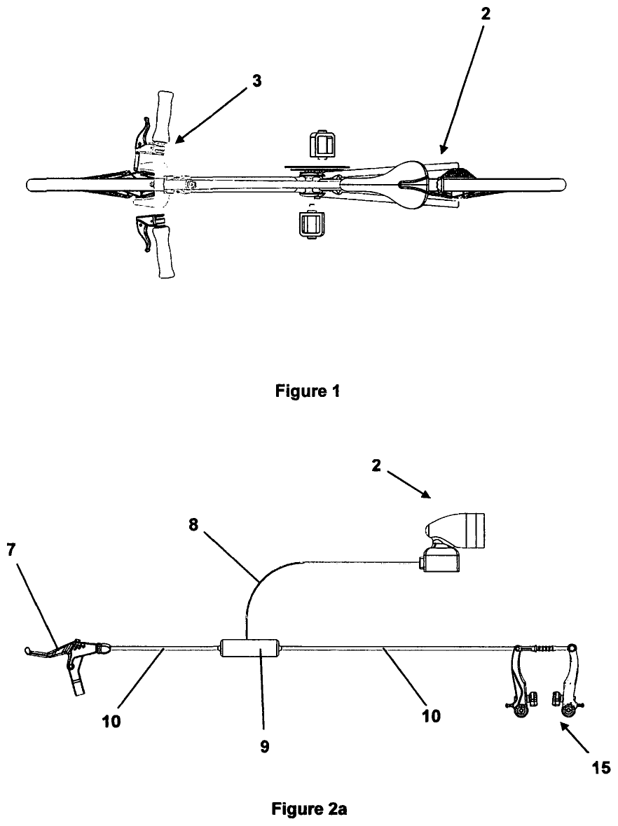

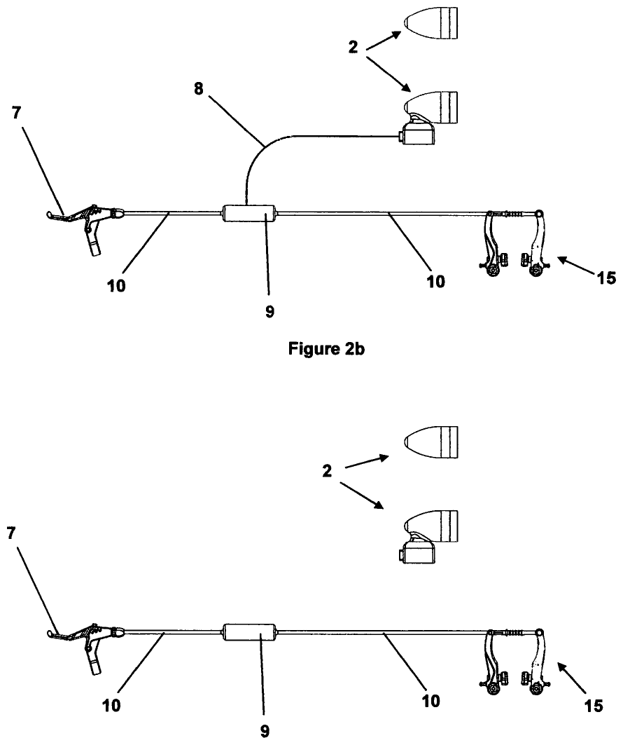

In an alternative or additional form, a further light unit or units similar to light unit 2 can be used as auxiliary unit(s) forming part of the overall system, or in place of the light unit 2. These are independent units, which can be independently attached or mounted on a bicycle, or elsewhere where convenient, such as on a user's bag or helmet or belt. Schematic examples of this type of arrangement are shown in FIGS. 2b and 2c.

These lights would work the same way as the main light. This means that they will also function as a brake light. They may consist of 3 rings or maybe have just 3 LED's or a single LED that gets progressively brighter. This increase in brightness or number of lit rings will be in sequence with the main light. This means there will be some form of wireless communication with the main light. This will be done by way of Bluetooth or a Radio Frequency transceiver. The implication is that each of these auxiliary lights will have to have its own power supply and control electronics.

In variations of the embodiment described above, a user interface can be built into the brake lever housing, that includes a visual indicator such as an LED that lets the user know that the brake light has been activated. This could also act as a ‘battery low’ warning or similar. This would be enabled by having a closed loop system that is always feeding back the signals from the sensor assembly to the user interface.

In other variations, a calibration process can be included to allow the user to match the braking force with the number of lights illuminated—that is, the level of braking force at which the rings will illuminate. The device can also be powered by a dynamo or similar, rather than the battery power source described for the embodiments above.

The use of a load cell for force measurement is advantageous as not only is there a direct linear relationship between force and deformation, the load cell also allows detection of the very start of a braking action, and also an accurate assessment of the magnitude of braking force applied. The system of the present invention directly measures the actual braking force applied by the user/rider. The system is sensitive to even the smallest application of braking force.

In contrast, a micro-switch system will only allow on/off binary actions in response to detecting a braking action. An accelerometer based system could be used to detect the magnitude of deceleration, but this will produce different results for riders of different mass.

By measuring the actual braking force applied, the system of the present invention can be set up to provide illumination progressively or with increasing intensity, to a level appropriate to the braking force. This then allows the provision of a visual form that intuitively allows other road users to gauge the braking intensity, and to react appropriately in response.

As outlined above, the power supply in the main embodiment described above (batteries and electronic circuitry necessary for powering and controlling the system) is contained in the light unit 2 (in the housing 4). A hard-wired connection runs between the sensor unit 3 and the light unit 2 to supply power to the sensor unit 3, and to transmit the force reading signal back to the control electronics in the light unit 2. For a fully wireless system the sensor unit 3 has a built in power supply. If auxiliary light units are used, each of these would also have their own power supply/battery.

Further, some bicycles use a hydraulic brake system where no cables are used to transmit force between the brakes and the brake lever. In this type of arrangement, the sensor unit is integrated into the brake lever assembly, to measure the amount of force applied by a user to the lever itself.

1. A bicycle brake light system, comprising:
a sensor assembly configured to measure force applied to a bicycle brake lever during braking;
a light unit comprising at least one light, the light unit configured to be mounted so that light from the at least one light can be directed substantially rearwards in use;
a controller configured to receive output from the sensor assembly and to control the light from the at least one light such that the intensity of light emitted from the at least one light is dependent on the amount of braking force applied.

2. The bicycle brake light assembly as claimed in claim 1, wherein the at least one light comprises a plurality of lights, the controller configured to illuminate the lights sequentially in order to increase the intensity of light emitted.

3. The bicycle brake light assembly as claimed in claim 2, wherein the plurality of lights are arranged to form two or more rings.

4. The bicycle brake light assembly as claimed in claim 3, wherein the two or more rings are arranged substantially concentrically.

5. The bicycle brake light assembly as claimed claim 4, wherein the controller is configured to illuminate the rings from the inner ring outwards.

6. The bicycle brake light assembly as claimed in claim 2, wherein the plurality of lights are arranged to form three rings.

7. The bicycle brake light assembly as claimed in claim 2, wherein the plurality of lights comprise LED lights.

8. The bicycle brake light assembly as claimed in claim 1, wherein the light unit further comprises a light housing, the controller and housing configured so that the controller is located in the housing.

9. The bicycle brake light assembly as claimed in claim 1, wherein the sensor assembly comprises a strain gauge, mounted to in use measure the force applied to a brake lever.

10. The bicycle brake light assembly as claimed in claim 9, wherein the strain gauge is mounted in line with the brake cable associated with the brake lever.

11. The bicycle brake light assembly as claimed in claim 10, wherein the sensor assembly further comprises an elongate main body having a pair of poles mounted one at each end to extend from one side thereof, the free ends of the brake cable connected one to each of the poles at or towards the outer end of the pole, the strain gauge mounted on the surface of the main body between the poles.

12. The bicycle brake light assembly as claimed in claim 11, wherein the main body comprises at least one cut-out section on the opposite side of the main body to the poles and strain gauge.

13. The bicycle brake light assembly as claimed in claim 12, wherein the cut-out section or sections is/are substantially opposite the strain gauge.

14. The bicycle brake light assembly as claimed in claim 9, wherein the sensor unit further comprises a housing configured to hold and at least partly enclose the sensor unit.

15. The bicycle brake light assembly as claimed in claim 1, wherein the controller is configured to receive an output signal from the sensor assembly indicative of the force applied to the bicycle brake lever during braking and to convert this to an output voltage substantially proportional to the braking force.

16. The bicycle brake light assembly as claimed in claim 15, wherein the output voltage is substantially between zero and five volts.

17. The bicycle brake light assembly as claimed in claim 15, wherein the control circuitry is configured to step up the intensity of the light emitted when the output voltage reaches each one of a series of pre-set levels.

18. The bicycle brake light assembly as claimed in claim 1, further comprising a hardwired connection between the sensor assembly and the light unit.

19. The bicycle brake light assembly as claimed in claim 1, wherein the sensor assembly further comprises a wireless transmitter, and the light unit further comprises a wireless receiver configured to receive a signal transmitted from the wireless transmitter, the signal indicative of the amount of braking force applied.

20. The bicycle brake light assembly as claimed in claim 19, wherein the transmitter and receiver are configured to use the Bluetooth protocol.

21. (canceled)
